(19) United States
(12) Patent Application Publication
(10) Pub. No.: US 2023/0391951 A1
(43) Pub. Date: Dec. 7, 2023

(54) NOVEL (PER)FLUOROPOLYETHER POLYMERS AND USE THEREOF

(71) Applicant: SOLVAY SPECIALTY POLYMERS ITALY S.P.A., Bollate (Milano) (IT)

(72) Inventors: Mary Thomson, Milano (MI) (IT); Simonetta Antonella Fontana, Milano (MI) (IT); Andrea Lotierzo, Brugherio (MB) (IT)

(73) Assignee: SOLVAY SPECIALTY POLYMERS ITALY S.P.A., Bollate (Milano) (IT)

(21) Appl. No.: 18/249,032

(22) PCT Filed: Sep. 30, 2021
(86) PCT No.: PCT/EP2021/076929

§ 371 Date: Apr. 13, 2023

(30) Foreign Application Priority Data
Oct. 14, 2020 (EP) 20201713.3

(51) Int. Cl. C08G 65/00; C08G 65/333; C08G 65/336; C09D 5/02; C09D 171/03

(52) U.S. Cl. CPC C08G 65/007; C08G 65/33351; C08G 65/336; C09D 5/025; C09D 171/03; C08G 2650/04; C08G 2650/48

(57) ABSTRACT

The present invention relates to compositions comprising novel (per)fluoropolyether polymers, endowed with antimicrobial properties, to methods for the manufacture thereof and to their use to provide compositions having antimicrobial properties.

### CROSS-REFERENCE TO RELATED PATENT APPLICATIONS

This application claims the priority of patent application filed on 14 Oct. 2020 in EUROPE with Nr. 20201713.3, the whole content of this application being incorporated herein by reference for all purposes.

### TECHNICAL FIELD

The present invention relates to compositions comprising novel

(per)fluoropolyether polymers, endowed with antimicrobial properties, to methods for the manufacture thereof and to their use to provide compositions having antimicrobial properties.

### BACKGROUND ART

The use of (per)fluoropolyether (PFPE) polymers as ingredients in the manufacture of anti-soil coating compositions, for coating different types of substrates is known in the art. For example, EP 3312242 (3M Innovative Properties Company) discloses protective coating compositions with mixed functionalities, wherein PFPE are mentioned among other backbones; WO 2016/079195 (Solvay Specialty polymers Italy S.p.A.) discloses zwitterionic derivatives of PFPE, which are disclosed as suitable for coating applications; WO 2019/106366 (Sphere Fluidic Limited) discloses surfactants comprising perfluoropolyether structure.

Among the others, the coating of security documents, such as notably banknotes, using such PFPE polymers was disclosed for example in WO 2012/055885 (Oberthur Fiduciaire SAS) and WO 2013/045496 (Oberthur Fiduciaire SAS, Solvay Specialty Polymers Italy S.p.A.).

Coatings having anti-bacterial and/or anti-viral properties have been also disclosed in the art, for example in JP2014237227 (Central Glass Co.), TW201512339 (Alpha Bright Int. Co., LTD.), US 2015/191608 (Industrial Academic Cooperation Group Seoul National University; Samsung Electronics CO., LTD.; Snu R And DB Foundation); WO 2016/153230 (Ceko Co., LTD.); CN105176342 (Xiamen Boensi Applic Material Science and Technology CO., LTD.).

However, the recent spread of coronavirus disease (COVID-19) caused by severe acute respiratory syndrome coronavirus 2 (SARS-CoV-2) increased the importance of developing compositions endowed with antimicrobial properties (including but not limited to anti-bacterial, anti-viral and antifungal properties), such compositions being suitable for coating a wide variety of substrates, including notably paper, banknotes, glass and plastic, notably for electronic and smart devices.

### SUMMARY OF INVENTION

Within this frame, the Applicant faced the problem of developing novel polymers endowed with antimicrobial properties.

More in particular, the Applicant developed novel (per)fluoropolyether (PFPE) polymers endowed with antimicrobial properties, said properties being provided by specific functional group(s) bonded to the (per)fluoropolyether backbone.

Advantageously, the chemical structure of the novel PFPE polymers according to the present invention is such that the polymers are endowed with antimicrobial properties, while providing the properties of coatings, such as notably transparency together with water- and oil-repellency.

Thus, in a first aspect, the present invention relates to a (per)fluoropolyether polymer [(polymer (P^{P})] comprising a (per)fluoropolyether chain [chain (R_{pf})] having two chain ends [chains (Re)] bonded to opposite sides of said chain (R_{pf}), wherein :
a first chain end comprises at least one group comprising a quaternary ammonium salt group [group (N⁺)] and at least one group selected in the group consisting of : alkoxysilane [group (Si)] and cross-linkable group, preferably selected from unsaturated moiety [group (U)] and epoxy [group (E)]; and
the second chain end comprises either a perfluoroalkyl group or a quaternary ammonium salt group [group (N⁺)] and at least one group selected in the group consisting of : alkoxysilane [group (Si)] and cross-linkable group, preferably selected from unsaturated moiety [group (U)] and epoxy [group (E)].

In a preferred aspect, the present invention relates to a bifunctional (per)fluoropolyether polymer [polymer (P^{P-bif})] comprising a (per)fluoropolyether chain [chain (R_{pf})] having two chain ends [chains (Re)] bonded to opposite sides of said chain (R_{pf}), wherein both chain ends comprise at least one group comprising a quaternary ammonium salt group [group (N⁺)] and at least one group selected in the group consisting of : alkoxysilane [group (Si)] and cross-linkable group, preferably selected from unsaturated moiety [group (U)] and epoxy [group (E)].

In another preferred aspect, the present invention relates to a monofunctional (per)fluoropolyether polymer [polymer (P^{P-monof})] comprising a (per)fluoropolyether chain [chain (R_{pf})] having two chain ends [chains (Re)] bonded to opposite sides of said chain (R_{pf}), wherein one chain end bears one perfluoroalkyl group and the other chain end comprises at least one quaternary ammonium salt group [group (N⁺)] and at least one group selected in the group consisting of: alkoxysilane [group (Si)] and cross-linkable group, preferably selected from unsaturated moiety [group (U)] and epoxy [group (E)].

Each of the above mentioned polymer (P^{P-bif}) and polymer (P^{P-monof}) are advantageously provided as polymers per se or in a composition comprising a mixture of the two polymers.

Thus, in a further aspect, the present invention relates to a composition [composition (CP)] comprising:
a (per)fluoropolyether polymer [polymer (P^{P-bif})] comprising a (per)fluoropolyether chain [chain (R_{pf})] having two chain ends [chains (Re)] bonded to opposite sides of said chain (R_{pf}), wherein both chain ends comprise at least one group comprising a quaternary ammonium salt group [group (N⁺)] and at least one group selected in the group consisting of: alkoxysilane [group (Si)] and cross-linkable group, preferably selected from unsaturated moiety [group (U)] and epoxy [group (E)]; and
a (per)fluoropolyether polymer [polymer (P^{P-monof})] comprising a (per)fluoropolyether chain [chain (R_{pf})] having two chain ends [chains (Re)] bonded to opposite sides of said chain (R_{pf}), wherein one chain end bears one perfluoroalkyl group and the other chain end comprises at least one quaternary ammonium salt group [group (N⁺)] and at least one group selected in the group consisting of: alkoxysilane [group (Si)] and cross-linkable group, preferably selected from unsaturated moiety [group (U)] and epoxy [group (E)].

According to another preferred embodiment, said composition (C^{P}) comprises up to 85 wt. %, preferably up to 95 wt. % and even more preferably up to 99 wt. % of said polymer (P^{P-bif}), the remaining part up to 100 wt. % of said composition (C^{P}) being provided either by said polymer (P^{P-monof}) or by side-products of the chemical reaction.

Composition (C^{P}) of the invention can be used as such to provide a coating having antimicrobial properties or it can be used as antimicrobial ingredient (also referred to as “additive”) in a solvent [solvent (S)].

Thus, in a second aspect, the present invention relates to a composition [composition (DIL)] comprising composition (C^{P}) as defined above and at least one solvent [solvent (S)] selected in the group comprising : (per)fluorinated fluids, optionally comprising at least one unsaturated moiety; hydrogenated fluids, optionally comprising at least one unsaturated moiety.

In a third aspect, the present invention relates to the use of composition (C^{P}) or composition (DIL) as described above, to impart antimicrobial properties to a substrate.

### DESCRIPTION OF EMBODIMENTS

For the purpose of the present description and of the following claims:
the use of parentheses around symbols or numbers identifying the formulae, for example in expressions like “polymer (P)”, etc., has the mere purpose of better distinguishing the symbol or number from the rest of the text and, hence, said parenthesis can also be omitted;
the acronym “PFPE” stands for “(per)fluoropolyether” and, when used as substantive, is intended to mean either the singular or the plural from, depending on the context;
the term “(per)fluoropolyether” is intended to indicate fully or partially fluorinated polyether polymer;
the expression “polymer (P^{P})” is intended to indicate both polymer (P^{P-bif}) and polymer (P^{P-monof}) unless otherwise specified;
the expression “endowed with antimicrobial properties” is intended to indicate that the polymer is capable of killing or stopping the growth of microorganism, such as bacteria, virus and fungi.

Preferably, in polymer (P^{P}), said chain (R_{pf}) is a chain of formula

—D—(CFX^{#})_{z1}—O(R_{f})(CFX*)_{z2}—D*—
wherein
z1 and z2, equal or different from each other, are equal to or higher than 1;
X# and X*, equal or different from each other, are —F or —CF₃, provided that when z1 and/or z2 are higher than 1, X^{#} and X* are —F;
D and D*, equal or different from each other, are a sigma bond, an alkylene chain comprising from 1 to 6 and even more preferably from 1 to 3 carbon atoms, said alkyl chain being optionally substituted with at least one perfluoroalkyl group comprising from 1 to 3 carbon atoms;
(R_{f}) comprises, preferably consists of, repeating units R°, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂)—, wherein each of W, equal or different from each other, are F, Cl, H;
(iv) —CF₂CF₂CF₂CF₂O—;
(v) —(CF₂)ⱼ-CFZ—O— wherein j is an integer from 0 to 3 and Z is a group of general formula —O—R(fR_{(f-a)}-T, wherein R_{(f-a)} is a fluoropolyoxyalkene chain comprising a number of repeating units from 0 to 10, said recurring units being chosen among the following : —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.

Preferably, z1 and z2, equal or different from each other, are from 1 to 10, more preferably from 1 to 6 and even more preferably from 1 to 3.

More preferably, D and D*, equal or different from each other, are a sigma bond, or a chain of formula —CH₂—, —CH₂CH₂— or —CH(CF₃)—.

Preferably, chain (Rf) complies with the following formula:

—[(CFX¹O)g₁(CFX²CFX³O)g₂(CF₂CF₂CF₂O)g₃(CF₂CF₂CF₂CF₂O)g₄]— (R_{f}-I)
wherein
X¹ is independently selected from —F and —CF₃,
X², X³, equal or different from each other and at each occurrence, are independently —F, —CF₃, with the proviso that at least one of X is —F;
g1, g2 , g3, and g4, equal or different from each other, are independently integers ≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

—[(CF₂CF₂O)a₁(CF₂O)a₂]— (R_{f}-IIA)
wherein:
a1 and a2 are independently integers 0 such that the number average molecular weight is between 400 and 10,000, preferably between 400 and 5,000; both al and a2 are preferably different from zero, with the ratio a1/a2 being preferably comprised between 0.1 and 10;

—[(CF₂CF₂O)b₁(CF₂O)b₂(CF(CF₃)O)b₃(CF₂CF(CF₃)O)b₄]— (R_{f}-IIB)
wherein:
b1, b2, b3, b4, are independently integers ≥0 such that the number average molecular weight is between 400 and 10,000, preferably between 400 and 5,000; preferably b1 is 0, b2, b3, b4 are >0, with the ratio b4/(b2+b3) being ≅1;

—[(CF₂CF₂O)c₁(CF₂O)c₂(CF₂(CF₂)_{cw}CF₂O)c₃]— (R_{f}-IIC)
wherein:
cw=1 or 2;
c1, c2, and c3 are independently integers ≥0 chosen so that the number average molecular weight is between 400 and 10,000, preferably between 400 and 5,000; preferably c1, c2 and c3 are all >0, with the ratio c3/(c1+c2) being generally lower than 0.2; (Rf-IID)

—[(CF₂CF(CF₃)O)_{d}]—
wherein:
d is an integer >0 such that the number average molecular weight is between 400 and 10,000, preferably between 400 and 5,000;

—[(CF₂CF₂C(Hal*)₂O)e₁—(CF₂CF₂CH₂O)e₂—(CF₂CF₂CH(Hal*)O)e₃]— (R_{f}-IIE)
wherein:
Hal*, equal or different at each occurrence, is a halogen selected from fluorine and chlorine atoms, preferably a fluorine atom;
e1, e2, and e3, equal to or different from each other, are independently integers ≥0 such that the (e1+e2+e3) sum is comprised between 2 and 300.

Still more preferably, chain (R_{f}) complies with formula (R_{f}-III) here below:

—[(CF₂CF₂O)a₁(CF₂O)a₂]— (R_{f}-III)
wherein:
a1, and a2 are integers >0 such that the number average molecular weight is between 400 and 10,000, preferably between 400 and 5,000, with the ratio a1/a2 being generally comprised between 0.1 and 10, more preferably between 0.2 and 5.

Preferably, group (N⁺) is preferably selected in the group comprising, more preferably consisting of:

(N⁺—I)

—N⁺(R^{h1})(R^{h2})(R^{h3})
wherein
each of R^{h1}, R^{h2}, and R^{h3} is independently selected from linear or branched alkyl chain having from 1 to 20, more preferably from 1 to 18, and even more preferably from 3 to 18 carbon atoms, said alkyl chain being optionally substituted with one or more —OH groups; benzyl or at least two of R^{h1}, R^{h2}, and R^{h3} together with the nitrogen atom form an aliphatic ring comprising 4 or 5 carbon atoms and the nitrogen atom.

Preferably, at least one of R^{h1}, R^{h2}, and R^{h3} is a linear or branched alkyl chain having from 6 to 20, more preferably from 6 to 18 carbon atoms.

Preferably, at least two of R^{h1}, R^{h2}, and R^{h3} are independently a linear or branched alkyl chain having from 1 to 6, more preferably from 1 to 4 carbon atoms. Preferably, any of polymer (P^{P-bif}) and polymer (P^{P-monof}) comprises a counter-ion for said group (N⁺).

More preferably, said counter-ion is selected from halogen atom, such as chlorine, iodine, bromine; mesylate and tosylate. Halogen atom is more preferred.

Preferably, in any of polymer (P^{P}), polymer (P^{P-bif}) and polymer (P^{P-monof}), the chain(s) (Re) is(are) bonded to said chain (R_{pf}) via a sigma bond or via a poly(oxy)alkylene chain [chain (Rₐ)].

More preferably, said chain (Rₐ) comprises from 1 to 50 fluorine-free oxyalkylene units, said units being the same or different each other and being selected from —OCH(J)CH(J*)—, wherein each of J and J* is independently selected from hydrogen atom, straight or branched alkyl or aryl, preferably hydrogen atom, methyl, ethyl or phenyl.

Preferably, any of polymer (P^{P}), polymer (P^{P-bif}) and polymer (P^{P-monof}) comprises at its chain end(s) said group (U).

Preferably, said group (U) is selected in the group consisting of:

(U—I)—O—C(═O)—CRH═CH₂

(U—II)—O—C(═O)—NH—CO—CRH═CH₂

(U—III)—O—C(═O)—RA—CRH═CH₂
wherein
R_{H} is H or a C₁-C₆ alkyl group;
R^{A} is selected from the group consisting of (R^{A}-I) and (R^{A}-II):
(R^{A}-I)

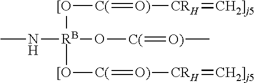

wherein
each of j5 is independently 0 or 1 and
RB is a divalent, trivalent or tetravalent group selected from the group consisting of C₁-C₁₀ aliphatic group; C₁-C₁₂ cycloaliphatic group;
C₅-C₁₄ aromatic or alkylaromatic group, optionally comprising at least one heteroatom selected from N, O and S;
(R^{A}-II)

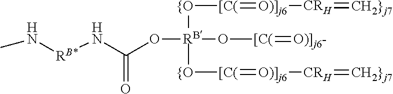

wherein
j6 is 0 or 1;
each of j7 is independently 0 or 1;
R^{B}′ is a divalent, trivalent or tetravalent group selected from the group consisting of C₁-C₁₀ aliphatic group; C₁-C₁₂ cycloaliphatic group; C₅-C₁₄ aromatic or alkylaromatic group, optionally comprising at least one heteroatom selected from N, O and S; and
R^{B}* has the same meanings defined above for R^{B}′ or it is a group of formula (R^{B}-I):

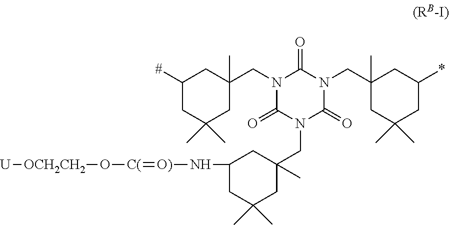

wherein
substituent U is selected from the groups (U-I) to (U-III) as defined
above
and
* and # indicate the bonding site to the nitrogen atoms in formula (R^{A}-II) above.

Preferably, when said chains (Re) comprise group (U), said chains (Re) are bonded to said chain (R_{pf}) via group of formula :

*—R¹⁰—NH—C(═O)—O—R¹¹—#
wherein
* indicate the bond to group (U)
# indicate the bond to chain (R_{pf})
R¹⁰ is a linear or branched alkyl chain having from 1 to 6 carbon atoms, optionally substituted with a group comprising a tri-alkoxy-silyl group;
R¹¹ is a sigma bond or a poly(oxy)alkylene chain [chain (Rₐ\hat{ })], wherein said chain (Rₐ\hat{ }) comprises from 1 to 50 fluorine-free oxyalkylene units, said units being the same or different each other and being selected from —CH(J*)CH(J)—O, wherein each of J and J* is independently selected from hydrogen atom, straight or branched alkyl or aryl, preferably hydrogen atom, methyl, ethyl or phenyl.

According to an alternative embodiment, each of polymer (P^{P-bif}) and polymer (P^{P-monof}) comprises at its chain end(s) group (Si).

Preferably, said group (Si) is a group of formula:

—Si—(OR³⁰)₃
wherein R³⁰ is a linear or branched alkyl chain having from 1 to 12 carbon atoms.

Polymer (P^{P-bif}) as defined above can be advantageously prepared starting from (per)fluoropolyether (PFPE) polymers [PFPE polymer (bif)] comprising a (per)fluoropolyether chain [chain (R_{pf})] having two chain ends bonded to opposite sides of said chain (R_{pf}), wherein both chain ends comprises at least one —OH group.

Polymer (P^{P-monof}) as defined above can be advantageously prepared starting from (per)fluoropolyether (PFPE) polymers [PFPE polymer (monof)] comprising a (per)fluoropolyether chain [chain (R_{pf})] having two chain ends bonded to opposite sides of said chain (R_{pf}), wherein one of said chain ends comprises at least one —OH group and the other chain end comprises a perfluoroalkyl group.

The polymers (P^{P-bif}) and (P^{P-monof}) of the invention, as well as the composition containing the same can be prepared starting from reactants and according to methods comprising reactions known in the art.

For example, a first intermediate composition [composition (INT¹)] can be manufactured via a method [method (M1)] comprising the following steps:
(i) providing at least one PFPE polymer selected in the group consisting of PFPE polymer (bif) or PFPE polymer (monof) as defined above;
(ii) converting at least part of the —OH groups of said PFPE polymer into epoxy groups, thus obtaining composition (INT1) comprising:
a (per)fluoropolyether polymer [polymer P^{bif-INT1}] comprising a chain (R_{pf}) having two chain ends bonded to opposite sides of said chain (R_{pf}), wherein both chain ends comprise an epoxy group,
optionally in admixture with a (per)fluoropolyether polymer [polymer P^{monof-INT1}] comprising a chain (R_{pf}) having two chain ends bonded to opposite sides of said chain (R_{pf}), wherein one chain end comprises an epoxy group and the other chain end comprises a perfluoroalkyl group.

Said composition (INT1) constitutes another aspect of the present invention.

The (per)fluoropolyether (PFPE) polymer used as starting material in step (i) is preferably a PFPE polymer (bif) or PFPE polymer (monof) complying with the following formula:

T—(R_{pf})—[OCH(J)CH(J*)]ₜ₂—OH (PFPE-i)
wherein
(R_{pf}) is as defined above,
T is —OH, a perfluoroalkyl group or a group of formula

HO—[CH(J*)CH(J)O]ₜ₁—,
t1 and t2, each independently, is 0 or an integer from 1 to 50, and
J and J*, each independently, is as defined above for chain (Ra).

Preferably, step (ii) is performed by contacting said PFPE polymer (bif) or PFPE polymer (monof) with at least one compound comprising an epoxy group [compound (E)].

Preferably, said compound (E) is selected from the group comprising, preferably consisting of: epichlorohydrin, epibromohydrin, epiiodohydrin.

It will be understood by those skilled in the art that under step (ii), preferably about 100% of the —OH groups of the starting PFPE polymer (either mono-functional PFPE or di-functional PFPE) are converted into epoxy groups.

However, partial conversion of the —OH groups can also be obtained. Under this embodiment, in the subsequent steps of the above method, the polymers obtained will comprise a statistical combination of different substituents at their chain ends will be obtained.

Advantageously, a second intermediate composition [composition (INT2)] can be manufactured via a method [method (M2)] comprising:
(iii) contacting the composition (INT1) as defined above obtained in step
(ii) with at least one compound bearing a secondary amine or a tertiary amine bearing one —OH group, so as to convert said —O-epoxy groups into groups of formula:

—O—Rₓ₁—CH(OH)_{Rx2}—N(R^{h1})(R^{h2})
wherein
Rₓ₁ is a linear or branched alkyl chain comprising from 1 to 6 carbon atoms, a cycloaliphatic ring having 5 or 6 members, or an aromatic ring having 5 or 6 members, said cycloaliphatic or aromatic ring being optionally substituted with at least one heteroatom selected in the group consisting of : nitrogen, oxygen and sulphur;
R_{X2} is a linear or branched alkyl or alkoxy chain comprising 1 to 30 carbon atoms, optionally substituted with one or more —OH groups and optionally comprising a poly(oxy)alkylene chain, a cycloaliphatic ring having 5 or 6 members, or an aromatic ring having 5 or 6 members, said cycloaliphatic or aromatic ring being optionally substituted with at least one heteroatom selected in the group consisting of: nitrogen, oxygen and sulphur; and
Rₕ₁ and Rₕ₂ are as defined above in formula (N⁺—I);
thus obtaining composition (INT²) comprising:
a (per)fluoropolyether polymer [polymer P^{bif-INT2}] comprising a chain (R_{pf}) having two chain ends bonded to opposite sides of said chain (R_{pf}), wherein both chain ends comprise a group of formula:

—O—R^{x1}—CH(OH)—R^{x2}—N(R^{h1})(R^{h2})
wherein Rₓ₁, Rₓ₂, Rₕ₁ and Rₕ₂ are as defined above,
optionally in admixture with a (per)fluoropolyether polymer [polymer P^{monof-INT2}] comprising a chain (R_{pf}) having two chain ends bonded to opposite sides of said chain (R_{pf}), wherein one chain end comprises a perfluoroalkyl group and the other chain end comprises a group of formula:

—O—Rₓ₁—CH(OH)—Rₓ₂—N(R^{h1})(R^{h2})
wherein Rₓ₁, Rₓ₂, Rₕ₁ and Rₕ₂ are as defined above.

Said composition (INT2) constitutes another aspect of the present invention.

Preferably, under step (iii), said compound bearing a secondary amine complies with the following formula:

HN(R^{h1})(R^{h2})
wherein
each of R^{h1} and R^{h2} is independently selected from linear or branched alkyl chain having from 1 to 20 carbon atoms, preferably from 1 to 6, more preferably from 1 to 4, optionally substituted with one or more —OH groups, benzyl or
R^{h1} and R^{h2} together with the nitrogen atom form an aliphatic ring comprising 4 or 5 carbon atoms and the nitrogen atom.

More preferably, said at least one secondary amine is selected in the group comprising, even more preferably consisting of: dimethylamine, diethylamine, dipropylamine, diisopropylamine, dibutylamine, diisobutylamine, ditertbutylamine, dihexylamine, dioctylamine, didecylamine, didodecylamine.

Dimethylamine, diethylamine, dipropylamine, dibutylamine are more preferred.

Preferably, said compound bearing a tertiary amine bearing at least one —OH group complies with the following formula:

HO—(R_{X3})—N(R^{h3})(R^{h4})
wherein
R_{X3} is a linear or branched alkyl or alkoxy chain comprising 1 to 30 carbon atoms, optionally substituted with one or more —OH groups and optionally comprising a poly(oxy)alkylene chain, a cycloaliphatic ring having 5 or 6 members, or an aromatic ring having 5 or 6 members, said cycloaliphatic or aromatic ring being optionally substituted with at least one heteroatom selected from: nitrogen, oxygen or sulphur;
each of R^{h3} and R^{h4} is independently selected from linear or branched alkyl chain having from 1 to 20 carbon atoms, preferably from 1 to 4, optionally substituted with one or more —OH groups, benzyl or
R^{h3} and R^{h4} together with the nitrogen atom form an aliphatic ring comprising 4 or 5 carbon atoms and the nitrogen atom or
R^{h3} and R^{h4} together with R_{X3} form an aromatic ring comprising 4 or 5 carbon atoms and the nitrogen atom.

Preferably, the compound bearing a tertiary amine bearing one —OH group is selected from 2-(diethylamino)ethanol, 3-dimethylamino-1-propanol.

Further, the polymers (P^{P-bif}) and (P^{P-monof}) according to the present invention can be manufactured via a method [method (M3)] comprising the steps of:
(iv) contacting composition (INT2) as defined above obtained in step (iii) with a compound selected from: alkyl halides, benzyl halides, alkyl sulfonate and alkyl aryl sulfonate,
so as to convert groups of formula —O—R3 Rₓ₁—CH(OH)—Rₓ₁—N(R^{h1})(R^{h2}) into —O—R3 Rₓ₁—CH(OH)—Rₓ₂—N+(R^{h1})(R^{h2})(R^{h3})
wherein Rₓ₁, Rₓ₂, Rₕ₁ and Rₕ₂ are as defined above and
R^{h3} is linear or branched alkyl or alkoxy chain comprising 1 to 30 carbon atoms, optionally substituted with one or more —OH groups and optionally comprising a poly(oxy)alkylene chain, a cycloaliphatic ring having 5 or 6 members, or benzyl group;
(v) contacting the mixture obtained in step (iv) with compound selected in the group consisting of:
a compound [A] bearing at least one group (U) as defined above, and at least one halogen atom or at least one isocyanate group; or
a compound [B] bearing at least one group (E) as defined above, and at least one halogen atom or at least one isocyanate group; or
a compound [C] bearing at least one group (Si) as defined above, and at least one halogen atom or at least one isocyanate group, thus obtaining polymer (P^{P-bif}) or polymer (P^{P-monof}).

Preferably, under step (iv), the reaction with alkyl halide is preferred; more preferably said alkyl halide is selected from: iodooctane and bromooctane.

Preferably, under step (v), the reaction with compound [A] is preferred.

Preferably, under step (v), said compound [A] complies with the following formula:

O═C═N—R²⁰—R²¹—CRH═CH₂
wherein
R_{H} has the same meanings defined above for group (U);
R²⁰ is a linear or branched alkyl chain having from 1 to 6 carbon atoms, optionally substituted with a group comprising a tri-alkoxy-silyl group; and
R²¹ is a divalent group of formula —O—R3 C(═O)—, —O—R3 C(═O)—NH—CO—, —O—R3 C(═O)—RA— wherein R^{A} is as defined above for group (U-III).

More preferably, said compound [A] is selected in the group comprising, even more preferably consisting of: isocyanatoethylmethacrylate (IEM), allyl isocyanate, 3-isopropenyl-α,α-dimethylbenzyl isocyanate, vinyl isocyanate, acryloyl isocyanate, methacryloyl isocyanate, 2-isocyanatoethyl acrylate, 1,1-(bisacryloyloxymethyl) ethyl isocyanate, 2-(2-metacryloyloxyethyloxy) ethyl isocyanate.

It will be understood by those skilled in the art that the above steps from (i) to (iii) as well as steps from (i) to (v) can also be performed continuously, without separating each of the intermediate compositions (INTI) and (INT2).

Thus, another object of the present invention relates to a method for the manufacture of polymers (P^{P-bif}) and (P^{P-monof}) as defined above, said method comprising performing steps from (i) to (v) as defined above in a one-pot synthesis.

As disclosed above, said polymer (P^{P}) or said composition (C^{P}) can be used as such or it can be used as additive in a suitable solvent.

Preferably, composition (DIL) comprises from 0.01 to 50 wt. % of any of polymer (P^{P}) or composition (C^{P}) and from 50 to 99.99 wt. % of at least one solvent (S) as defined above.

Advantageously, said solvent (S) is selected from (per)fluoropolyether polymers having at the chain ends thereof at least one, more preferably at least two, unsaturated group(s).

According to another embodiment, the present invention relates to a method for imparting antimicrobial properties to an article, said method comprising:
(a) providing polymer (P^{P}) or composition (C^{P}) or composition (DIL) as defined above;
(b) proving an article having at least one surface;
(c) contacting said polymer (P^{P}) or said composition (C^{P}) or said composition (DIL) and at least one part of said at least one surface;
(d) coating said at least one part of said at least one surface with said polymer (P^{P}) or composition (C^{P}) or composition (DIL).

Advantageously, said article is selected from articles made of plastic, metal, glass, paper or textiles, such as notably cotton paper. More preferably, said article is a banknote.

Preferably, when at least one group (U) is present in any of polymer (P^{P}), composition (C^{P}) or composition (DIL), step (d) is performed by curing said composition (C^{P}) or composition (DIL) more preferably with UV rays.

Should the disclosure of any patents, patent applications, and publications, which are incorporated herein by reference conflict with the description of the present application to the extent that it may render a term unclear, the present description shall take precedence.

The invention will be herein after illustrated in greater detail by means of the Examples contained in the following Experimental Section; the Examples are merely illustrative and are by no means to be interpreted as limiting the scope of the invention.

### Experimental Section

### Materials and methods

Fomblin® Z DOL and Fluorolink® MD700 were obtained from Solvay Specialty Polymers Italy S.p.A.

The following were obtained by Aldrich: bis(trifluoromethyl)benzene, diethylamine, potassium hydroxide (≥85%), tetra-n-butylammonium bromide, epibromohydrin, acetonitrile, methanol, 1-iodooctane, 2,6-di-tert-butyl-4-methylphenol (BHT) and 2-isocyanatoethyl methacrylate.

SnapCure™ 1030 was obtained from Alfa Aesar Gmbh &Co.

¹H-NMR and ¹⁹F-NMR were recorded on a Agilent System 500 operating at 499.86 MHz for 1H and 470.30 MHz for 19F.

FT-IR spectra were measured with a ThermoScientific FTIR spectrophotometer on liquid samples as thin films on KBr. Spectra were acquired by co-adding 256 scans with a resolution of 2 cm⁻¹.

### Example 1—Synthesis of Polymer 1

Step 1: A 4-necked round bottom flask with 1.0 L capacity, kept under nitrogen atmosphere and equipped with a condenser, a mechanical stirrer, a thermometer probe and a dropping funnel, was charged with 200 g (EW=g/mol 795; 251.6 meq) of Fomblin® Z-DOL, 697 g of 1,3-bis(trifluoromethyl)benzene, 2 g of tetra-n-butylammonium bromide (6.2 meq) and 20 g of potassium hydroxide (355.2 meq). The flask was kept under stirring for 1 h at room temperature. Next, 86 g of epibromohydrin (628.9 meq) were added to the flask and the reaction mixture was heated to 70° C. for 3h. After this time, the reaction was cooled down and the mixture filtered. Distillation under reduced pressure (T=70.0° C., P=2 Pa) yielded 180.0 g of a clear pale yellow liquid.

¹H-NMR analysis confirmed that the obtained product was the starting Z-DOL with 90% of the hydroxyl end groups quantitatively converted into the 2,3-epoxy propane derivatives.

Step 2: A 4-necked round bottom flask of 0.5 L capacity, kept under nitrogen atmosphere and equipped with a condenser, a mechanical stirrer, a thermometer probe and a dropping funnel, was charged with 150 g of the product obtained in Step 1, 16 g of diethylamine (216.8 meq) and 75 g of 1,3- bis(trifluoromethyl)benzene. The resulting mixture was heated up to 70° and let under vigorous stirring for 8 hours. After this time, the reaction mixture was cooled to room temperature and washed with 80g of distilled water. After phase separation, the bottom organic phase was recovered and distilled under reduced pressure (T=70° C., P=2Pa) to remove the solvents obtaining 153 g of a yellow product. 1 H NMR analysis confirmed the quantitative opening of the epoxide ring to yield the amino-alcohol derivative.

Step 3: A 4-necked round bottom flask of 0.5 L capacity, kept under nitrogen atmosphere and equipped with a condenser, a mechanical stirrer, a thermometer probe and a dropping funnel, was charged with 100 g of the product obtained in Step 2, 26 g of 1-iodo octane (108.6 meq), 50 g of 1,3-bis(trifluoromethyl)benzene and 50 g of acetonitrile. The resulting mixture was heated up to 80° C. and left under vigorous stirring for 40 hours. After this time, the solvents were distilled under reduced pressure (T=70° C., P=2Pa) to remove the solvents, obtaining 123 g of a yellow viscous product.

¹H-NMR analysis confirmed the quantitative reaction of the alkyl halide with the tertiary amine to yield the target quaternary ammonium salt.

Step 4: A 4-necked round bottom flask of 0.25 L capacity, equipped with a condenser, a mechanical stirrer a dropping funnel and a thermometer probe, was charged with 100 g of the product obtained in Step 3, 3,9*10⁻² g of 2,6-di-tert-butyl-4-methylphenol (BHT), 6.1*10⁻² g of SnapCure™ 1030 and the obtained mixture was heated up to 50° C. 11.7 g of 2-isocyanato ethyl methacrylate (76.1 meq) were then slowly added to the flask. The temperature was raised to 60° C. and the reaction mixture was let under vigorous stirring for 3 hours. Thereafter, 1.1 g of methanol were added, the reaction mixture was stirred for further 2 hours and dried under reduced pressure (T=60° C., P =2Pa) obtaining 111.9 g of Polymer 1.

1. A (per)fluoropolyether polymer [(polymer (P^{P})] comprising a (per)fluoropolyether chain [chain (R_{pf})] having two chain ends [chains (Re)] bonded to opposite sides of said chain (R_{pf}), wherein:
a first chain end comprises at least one group comprising a quaternary ammonium salt group [group (N⁺)] and at least one group selected in the group consisting of: alkoxysilane [group (Si)], and cross-linkable group; and
the second chain end comprises either a perfluoroalkyl group or a quaternary ammonium salt group [group (N⁺)] and at least one group selected in the group consisting of: alkoxysilane [group (Si)] and cross-linkable group, preferably selected from unsaturated moiety [group (U)] z and epoxy [group (E)].

2. The polymer (P^{P}) according to claim 1, wherein said polymer (P^{P}) is:
a bifunctional (per)fluoropolyether polymer [polymer (P^{P-bif})] comprising a (per)fluoropolyether chain [chain (R_{pf})] having two chain ends [chains (Re)] bonded to opposite sides of said chain (R_{pf}), wherein both chain ends comprise at least one group comprising a quaternary ammonium salt group [group (N⁺)] and at least one group selected in the group consisting of : alkoxysilane [group (Si)], and cross-linkable group; or
a monofunctional (per)fluoropolyether polymer [polymer (P^{P-monof})] comprising a (per)fluoropolyether chain [chain (R_{pf})] having two chain ends [chains (Re)] bonded to opposite sides of said chain (R_{pf}), wherein one chain end bears one perfluoroalkyl group and the other chain end comprises at least one quaternary ammonium salt group [group (N⁺)] and at least one group selected in the group consisting of: alkoxysilane [group (Si)], and cross-linkable group.

3. The polymer (P^{P}) according to claim 1, wherein said chain (R_{pf}) is a chain of formula
—D—(CFX^{#})_{z1}—O(R_{f})(CFX*)_{z2}—D*—
wherein
z1 and z2, equal or different from each other, are equal to or higher than 1;
X # and X* , equal or different from each other, are —F or —CF₃, provided that when z1 and/or z2 are higher than 1, X # and X * are —F;
D and D*, equal or different from each other, are a sigma bond, an alkylene chain comprising from 1 to 6 carbon atoms, said alkyl chain being optionally substituted with at least one perfluoroalkyl group comprising from 1 to 3 carbon atoms;
(R_{f}) comprises repeating units R° , said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂—, wherein each of W, equal or different from each other, are F, Cl, H;
(iv) —CF₂CF₂CF₂CF₂O—;
(v) —(CF₂)3—CFZ-O- wherein j is an integer from 0 to 3 and Z is a group of general formula —O—R_{(f-a)}—T, wherein R(_{f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.

4. The polymer (P^{P}) according to claim 1, wherein said group (N⁺) is selected in the group comprising:
—N⁺(R^{h1})(R^{h2})(R^{h3})
wherein
each of R^{h1}, R^{h2}, and R^{h3} is independently selected from linear or branched alkyl chain having from 1 to 20 carbon atoms, said alkyl chain being optionally substituted with one or more —OH groups; benzyl or at least two of R^{h1}, R^{h2}, and R^{h3} together with the nitrogen atom form an aliphatic ring comprising 4 or 5 carbon atoms and the nitrogen atom.

5. The polymer (P^{P}) according to claim 1, wherein said cross-linkable group is an unsaturated moiety group (U), wherein group (U) is selected in the group consisting of:
(U—I)—O—C(═O)—CRH═CH₂
(U—II)—O—C(═O)—NH—CO—CRH═CH₂
(U—III)—O—C(═O)—RA—CRH═CH₂
wherein
R_{H} is H or a C₁-C₆ alkyl group;
R^{A} is selected from the group consisting of (R^{A}-I) and (R^{A}-II):
(R^{A}-I) 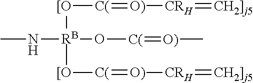
wherein
each of j5 is independently 0 or 12 and
R^{B} is a divalent, trivalent or tetravalent group selected from the group consisting of C₁-C₁₀ aliphatic group; C₃-C₁₂ cycloaliphatic group; C₅-C₁₄ aromatic or alkylaromatic group, optionally comprising at least one heteroatom selected from N, O and S;
(R^{A}-II) 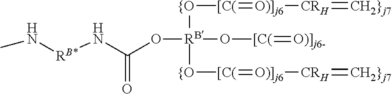
wherein
j6 is 0 or 1;
each of j7 is independently 0 or 1;
R^{B′} is a divalent, trivalent or tetravalent group selected from the group consisting of C₁-C₁₀ aliphatic group; C₃-C₁₂ cycloaliphatic group; C₅-C₁₄ aromatic or alkylaromatic group, optionally comprising at least one heteroatom selected from N, O and S; and
R^{B}* has the same meanings defined above for as R^{B′} or it is a group of formula (RR^{B}-I): 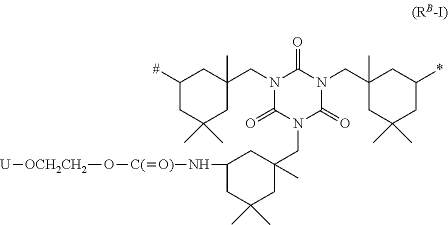
wherein
substituent U is selected from the groups (U-I) to (U-III) and
* and # indicate the bonding site to the nitrogen atoms in formula (R^{A}-II).

6. The polymer (P^{P}) according to claim 1, wherein:
when said chain end(s) comprise(s) said group (N⁺), said chain(s) (Re) is(are) bonded to said chain (R_{pf}) via a sigma bond or via a poly(oxy)alkylene chain [chain (Rₐ)];
when said chain(s) (Re) comprise(s) said cross-linkable group, wherein said cross-linkable group is an unsaturated moiety group (U), said chain(s) (Re) is(are) bonded to said chain (R_{pf}) via group of formula:
* —R¹⁰—NH—C(═O)—O—R¹¹—#
wherein
* indicate the bond to group (U);
# indicate the bond to chain (R_{pf});
R¹⁰ is a linear or branched alkyl chain having from 1 to 6 carbon atoms, optionally substituted with a group comprising a tri-alkoxy-silyl group;
R¹¹ is a sigma bond or a poly(oxy)alkylene chain [chain (Rₐ\hat{ })], wherein said chain (Rₐ\hat{ }) comprises from 1 to 50 fluorine-free oxyalkylene units, said units being the same or different each other and being selected from
—CH(J*)CH(J)—O, wherein each of J and J* is independently selected from hydrogen atom, straight or branched alkyl or aryl.

7. A composition [composition (C^{P})] comprising:
a (per)fluoropolyether polymer [polymer (P^{P-bif})] as defined in any one of claim 2; and
a (per)fluoropolyether polymer [polymer (P^{P-monof})] as defined in any one of claim 2.

8. A method [method (MO] for the manufacture of a first composition [composition (INTI), said method (Ml) comprising the following steps:
(i) providing at least one (per)fluoropolyether (PFPE) polymer comprising:
a (per)fluoropolyether chain [chain (R_{pf})] having two chain ends bonded to opposite sides of said chain (R_{pf}), wherein both chain ends comprises at least one —OH group [PFPE polymer (bif)] or a (per)fluoropolyether (PFPE) polymer comprising a (per)fluoropolyether chain [chain (R_{pf})] having two chain ends bonded to opposite sides of said chain (R_{pf}), wherein one of said chain ends comprises at least one —OH group and the other chain end comprises a perfluoroalkyl group [PFPE polymer (monof)];
(ii) converting at least part of the —OH groups of said PFPE polymer (bif) or said PFPE polymer (monof) into epoxy groups, thus obtaining composition (INTI) comprising:
a (per)fluoropolyether polymer [polymer P b i f-INT1 ] comprising a chain (R_{pf}) having two chain ends bonded to opposite sides of said chain (R_{pf}), wherein both chain ends comprise an epoxy group;
optionally in admixture with a (per)fluoropolyether polymer [polymer P^{monof-INT1}] comprising a chain (R_{pf}) having two chain ends bonded to opposite sides of said chain (R_{pf}), wherein one chain end comprises an epoxy group and the other chain end comprises a perfluoroalkyl group.

9. A composition (INTI) comprising:
-a (per)fluoropolyether polymer [polymer P^{bif-INT1}] comprising a chain (R_{pf}) having two chain ends bonded to opposite sides of said chain (R_{pf}), wherein both chain ends comprise an epoxy group;
optionally in admixture with a (per)fluoropolyether polymer [polymer P^{monof-INT1}] comprising a chain (R_{pf}) having two chain ends bonded to opposite sides of said chain (R_{pf}), wherein one chain end comprises an epoxy group and the other chain end comprises a perfluoroalkyl group.

10. A method [method (M2) for the manufacture of a composition [composition (INT2)], said method (M2) comprising the following steps: (iii) contacting composition (INT1) as defined in claim 9, with at least one compound bearing a secondary amine or a tertiary amine bearing one —OH group, so as to convert said —O-epoxy groups into groups of formula:
—O—Rₓ₁—CH(OH)_{Rx2}—N(R^{h1})(R^{h2})
wherein
Rₓ₁ is a linear or branched alkyl chain comprising from 1 to 6 carbon atoms, a cycloaliphatic ring having 5 or 6 members, or an aromatic ring having 5 or 6 members, said cycloaliphatic or aromatic ring being optionally substituted with at least one heteroatom selected in the group consisting of: nitrogen, oxygen and sulphur;
Rₓ₂ is a linear or branched alkyl or alkoxy chain comprising 1 to 30 carbon atoms, optionally substituted with one or more —OH groups and optionally comprising a poly(oxy)alkylene chain, a cycloaliphatic ring having 5 or 6 members, or an aromatic ring having 5 or 6 members, said cycloaliphatic or aromatic ring being optionally substituted with at least one heteroatom selected in the group consisting of: nitrogen, oxygen and sulphur; and wherein each of Rhl and Rₕ₂ is independently selected from linear or branched alkyl chain having from 1 to 20 carbon atoms, said alkyl chain being optionally substituted with one or more —OH groups, benzyl or at least two of Rhl and Rₕ₂ together with the nitrogen atom form an aliphatic ring comprising 4 or 5 carbon atoms and the nitrogen atom,
thus obtaining composition (INT²) comprising:
a (per)fluoropolyether polymer [polymer P^{biff-INT2}] comprising a chain (R_{pf}) having two chain ends bonded to opposite sides of said chain (R_{pf}), wherein both chain ends comprise a group of formula:
—O—Rₓ₁—CH(OH)_{Rx2}—N(R^{h1})(R^{h2});
optionally in admixture with a (per)fluoropolyether polymer [polymer P^{monof-INT2}] comprising a chain (R_{pf}) having two chain ends bonded to opposite sides of said chain (R_{pf}), wherein one chain end comprises a perfluoroalkyl group and the other chain end comprises a group of formula:
—O—Rₓ₁—CH(OH)_{Rx2}—N(R^{h1})(R^{h2}).

11. A composition (INT²) comprising:
a (per)fluoropolyether polymer [polymer P^{bif-INT2}] comprising a chain (R_{pf}) having two chain ends bonded to opposite sides of said chain (R_{pf}), wherein both chain ends comprise a group of formula:
—O—Rₓ₁—CH(OH)_{Rx2}—N(R^{h1})(R^{h2})
where Rₓ₁, Rₓ₂, Rₕ₁ and Rₕ₂ are as defined in claim 10;
optionally in admixture with a (per)fluoropolyether polymer [polymer P^{monof-INT2}] comprising a chain (R_{pf}) having two chain ends bonded to opposite sides of said chain (R_{pf}), wherein one chain end comprises a perfluoroalkyl group and the other chain end comprises a group of formula:
—O—Rₓ₁—CH(OH)_{Rx2}—N(R^{h1})(R^{h2})
wherein Rₓ₁, Rₓ₂, Rₕ₁ and Rₕ₂ are as defined in claim 10.

12. A method [method (M3)] for the manufacture of polymers (P^{P-bif}) and (P^{P-monof}) as defined in claim 2, said method (M3) comprising the steps of:

11. tacting composition (INT2) composition (INT2) comprising:
a (per)fluoropolyether polymer [polymer P^{bif-INT2}] comprising a chain (R_{pf}) having two chain ends bonded to opposite sides of said chain (R_{pf}), wherein both chain ends comprise a group of formula:
—O—Rₓ₁—CH(OH)_{Rx2}—N(R^{h1})(R^{h2})
wherein Rx1 is a linear or branched alkyl chain comprising from 1 to 6 carbon atoms, a cycloaliphatic ring having 5 or 6 members, or an aromatic ring having 5 or 6 members, said cycloaliphatic or aromatic ring being optionally substituted with at least one heteroatom selected in the group consisting of: nitrogen, oxygen and sulphur; RX2 is a linear or branched alkyl or alkoxy chain comprising 1 to 30 carbon atoms, optionally substituted with one or more —OH groups and optionally comprising a poly(oxy)alkylene chain, a cycloaliphatic ring having 5 or 6 members, or an aromatic ring having 5 or 6 members, said cycloaliphatic or aromatic ring being optionally substituted with at least one heteroatom selected in the group consisting of: nitrogen, oxygen and sulphur; and
wherein each of Rh1 and Rh2 is independently selected from linear or branched alkyl chain having from 1 to 20 carbon atoms, said alkyl chain being optionally substituted with one or more —OH groups, benzyl or at least two of Rh1 and Rh2 together with the nitrogen atom form an aliphatic ring comprising 4 or 5 carbon atoms and the nitrogen atom,
optionally in admixture with a (per)fluoropolyether polymer [polymer P^{monof-INT2}] comprising a chain (R_{pf}) having two chain ends bonded to opposite sides of said chain (R), wherein one chain end comprises a perfluoroalkyl group and the other chain end comprises a group of formula:
—O—Rₓ₁—CH(OH)_{Rx2}—N(R^{h1})(R^{h2})
with a compound selected from:
alkyl halides, benzyl halides, alkyl sulfonate and alkyl aryl sulfonate,
so as to convert groups of formula —O—Rₓ₁—CH(OH)_{Rx2}—N(R^{h1})(R^{h2})into
—O—Rₓ₁—CH(OH)_{Rx2}—N(R^{h1})(R^{h2})
wherein
Rₕ₁ and Rₕ₂ are H or a C₁-C₆ alkyl group; and
R^{h3} is linear or branched alkyl or alkoxy chain comprising 1 to 30 carbon atoms, optionally substituted with one or more —OH groups and optionally comprising a poly(oxy)alkylene chain, a cycloaliphatic ring having 5 or 6 members, or benzyl group;
(v) contacting the mixture obtained in step (iv) with compound selected in the group consisting of:
a compound [A] bearing at least one unsaturated moiety group (U), and at least one halogen atom or at least one isocyanate group; or
a compound [B] bearing at least one epoxy group (E), and at least one halogen atom or at least one isocyanate group; or
a compound [C] bearing at least one alkoxysilane group (Si), and at least one halogen atom or at least one isocyanate group, thus obtaining polymer (P^{P-bif}) or polymer (p^{P-monof}).

13. A composition [composition (DIL)] comprising composition (C^{P}) as defined in claim 7 and at least one solvent [solvent (5)] selected in the group comprising:
(per)fluorinated fluids, optionally comprising at least one unsaturated moiety; hydrogenated fluids, optionally comprising at least one unsaturated moiety.

14. A method for imparting antimicrobial properties to an article, said method comprising:
(a) providing polymer (P^{P}) as defined in claim 6,
composition (C^{P}) composition (C^{P}) comprising:
a (per)fluoropolyether polymer [polymer (P_{P-bif})], [polymer (P_{P-bif})] comprising a (per)fluoropolyether chain [chain (R_{pf})] having two chain ends[chains (Re)] bonded to opposite sides of said chain (R_{pf}), wherein both chain ends comprise at least one group comprising a quaternary ammonium salt group [group (N⁺)] and at least one group selected in the group consisting of alkoxysilane [group (Si)] and cross-linkable group; and
a (per)fluoropolyether polymer [polymer (P^{P-monof})], [polymer (P^{P-monof})] comprising a (per)fluoropolyether chain [chain (R_{pf})] having two chain ends [chains (Re)] bonded to opposite sides of said chain (R_{pf}), wherein one chain end bears one perfluoroalkyl group and the other chain end comprises at least one quaternary ammonium salt group [group (N⁺)] and at least one group selected in the group consisting of alkoxysilane [group (Si)] and cross-linkable group;
or composition (DIL) composition (DIL) comprising:
composition (C^{P}) and at least one solvent [solvent (S)] selected in the group comprising: (per)fluorinated fluids, optionally comprising at least one unsaturated moiety; hydrogenated fluids, optionally comprising at least one unsaturated moiety;
(b) proving an article having at least one surface;
(c) contacting said composition (C^{P}) or composition (DIL) and at least one part of said at least one surface;
(d) coating said at least one part of said at least one surface with said composition (C^{P}) or composition (DIL).

15. The method according to claim 14, wherein said article is selected from articles made of plastic, metal, glass, paper or textile.

16. The polymer (P^{P}) according to claim 1, wherein the cross-linkable group in each of the first chain end and the second chain end is selected from unsaturated moiety [group (U)], and epoxy [group (E)].

17. The polymer (P^{P}) according to claim 2, wherein the cross-linkable group in each of the polymer (P^{P-bif}) and the polymer (P^{P-monof}) is selected from unsaturated moiety [group (U)], and epoxy [group (E)].

18. The polymer (P^{P}) according to claim 3, wherein (R_{f}) consists of repeating units R°, said repeating units being independently selected from the group consisting of:
(i) —CFXO—, wherein X is F or CF3;
(ii) —CFXCFXO—, wherein X, equal or different at each occurrence, is F or CF₃, with the proviso that at least one of X is —F;
(iii) —CF₂CF₂CW2O—, wherein each of W, equal or different from each other, are F, Cl, H;
(iv) —CF₂CF₂CF₂CF₂O—;
(v) —(CF₂)j—CFZ—O— wherein j is an integer from 0 to 3 and Z is a group of general formula —O—R(f-a)—T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.
